(19) United States
(12) Patent Application Publication
(10) Pub. No.: US 2011/0297817 A1
(43) Pub. Date: Dec. 8, 2011

(54) L-SHAPED OPTICAL WAVEGUIDE DEVICE

(75) Inventors: Akiko Nagafuji, Osaka (JP); Noriyuki Juni, Osaka (JP)

(73) Assignee: NITTO DENKO CORPORATION, Osaka (JP)

(21) Appl. No.: 13/150,639

(22) Filed: Jun. 1, 2011

(30) Foreign Application Priority Data
Jun. 3, 2010 (JP) 2010-127712

(51) Int. Cl. G01J 1/04

(52) U.S. Cl. 250/227.28

(57) ABSTRACT

There is provided an L-shaped optical waveguide device, wherein a coupled end of a first I-shaped optical waveguide has a concave portion and a coupled end of a second I-shaped optical waveguide has a convex portion. A concave-convex joint is formed by fitting the concave portion with the convex portion to couple the first and second I-shaped optical waveguides to each other. A plurality of cores which belong to the second I-shaped optical waveguide having the convex portion respectively bend approximately at a right angle near a photoelectric conversion element to be optically coupled to the photoelectric conversion element.

### BACKGROUND OF THE INVENTION

1. Field of the Invention

The present invention relates to an L-shaped optical waveguide device manufactured in a combination of two I-shaped optical waveguides and a photoelectric conversion element.

2. Description of Related Art

A frame-shaped optical waveguide 40 shown in FIG. 6 is known (JP 2008-181411 A). The frame-shaped optical waveguide 40 is referred to as a conventional example 1. The frame-shaped optical waveguide 40 is fitted around the periphery of a display screen of an optical touch panel. In the frame-shaped optical waveguide 40 of the conventional example 1 shown in FIG. 6, a plurality of light-emitting-sided cores 41 and a plurality of light-receiving-sided cores 42 are integrally formed on a frame 43 in a state in which respective optical axes are aligned with each other. Accordingly, there is no need to previously align respective optical axes of the light-emitting-sided cores 41 with respective optical axes of the light-receiving-sided cores 42 when the frame-shaped optical waveguide 40 is fitted around the periphery of the display screen of the touch panel.

However, to manufacture the frame-shaped optical waveguide 40, a mold whose area is as large as that of the frame-shaped optical waveguide 40 and a glass mask are needed. Only a peripheral part is used and a large part inside is not used in the mold and the glass mask. As the frame-shaped optical waveguide 40 gets larger, the mold and the glass mask are becoming larger. As a result, a ratio of unused portions is becoming higher. Accordingly, as the frame-shaped optical waveguide 40 becomes larger, its productivity is getting lower.

On the other hand, it is possible to use the whole area of a mold and a glass mask when manufacturing an I-shaped optical waveguide. Accordingly, the I-shaped optical waveguide has high productivity and productivity thereof is not getting lower even when the I-shaped optical waveguide becomes larger. However, it is necessary to combine a plurality of I-shaped optical waveguides with an L-shaped optical waveguide or a frame-shaped optical waveguide when being fitted around a periphery of a display screen of a touch panel.

FIG. 7 shows an example of an L-shaped optical waveguide device 46 manufactured by combining two I-shaped optical waveguides 44, 45 together (conventional example 2). Photoelectric conversion elements 47, 48 are attached to respective short sides of the I-shaped optical waveguides 44, 45 and then respective plural cores 49, 50 are optically coupled to respective photoelectric conversion elements 47, 48. Two photoelectric conversion elements 47 and 48 are needed for the L-shaped optical waveguide device 46 of a conventional example 2. Further, a gap 51 is needed between the two I-shaped optical waveguides 44, 45 in the L-shaped optical waveguide device 46 of the conventional example 2. Furthermore, in the L-shaped optical waveguide device 46 of the conventional example 2, since it is impossible to directly couple the I-shaped optical waveguide 44 to the I-shaped optical waveguide 45, assembly accuracy of the two I-shaped optical waveguides 44, 45 is low in X and Y directions.

FIG. 8 shows another example of an L-shaped optical waveguide device 54 manufactured by a combination of two I-shaped optical waveguides 52, 53 (conventional example 3). A short side of an I-shaped optical waveguide 53 in an X direction is coupled to a long side of an I-shaped optical waveguide 52 in a Y direction. A plurality of cores 55 of the I-shaped optical waveguide 53 bend approximately at a right angle near a photoelectric conversion element 56 to be optically coupled to the photoelectric conversion element 56. The number of the photoelectric conversion element 56 may be one. There are no measures to prevent the I-shaped optical waveguide 53 in the X direction from distorting in a Y direction in the L-shaped optical waveguide device 54 of a conventional example 3. Consequently, assembly accuracy of the two I-shaped optical waveguides 52, 53 is low in the Y direction.

FIG. 9 shows still another example of an L-shaped optical waveguide device 59 manufactured by a combination of two I-shaped optical waveguides 57, 58 (conventional example 4). A short side of an I-shaped optical waveguide 58 in an X direction is coupled to a cutout section 60 in a long side of an I-shaped optical waveguide 57 in a Y direction. A plurality of cores 61 of the I-shaped optical waveguide 58 in the X direction respectively bend approximately at a right angle near a photoelectric conversion element 62 to be optically coupled to the photoelectric conversion element 62. The number of the photoelectric conversion element 62 may be one. There are still insufficient measures to prevent the I-shaped optical waveguide 58 in the X direction from distorting in the Y direction in the L-shaped optical waveguide device 59 of a conventional example 4. As a result, assembly accuracy of the two I-shaped optical waveguides 57, 58 is a little low in the Y direction.

### SUMMARY OF THE INVENTION

The frame-shaped optical waveguide 40 of the conventional example 1 has low productivity. Two photoelectric conversion elements 47, 48 are needed for the L-shaped optical waveguide device 46 of the conventional example 2. Further, a gap 51 is needed between two I-shaped optical waveguides 44 and 45. Furthermore, assembly accuracy of the two I-shaped optical waveguides 44, 45 is low in X and Y directions. Assembly accuracy in the L-shaped optical waveguide device 54 of the conventional example 3 is low in a Y direction. In the L-shaped optical waveguide device 59 of the conventional example 4, the assembly accuracy is a little low in a Y direction.

It is therefore an object of the present invention to form an L-shaped optical waveguide by a combination of a plurality of I-shaped optical waveguides with high productivity.

It is another object of the present invention to keep assembly accuracy of two I-shaped optical waveguides which constitute an L-shaped optical waveguide high in X and Y directions.

It is still another object of the present invention to minimize the number of the photoelectric conversion element to one.

A device made by adding a photoelectric conversion element to an L-shaped optical waveguide is referred to as an L-shaped optical waveguide device in the present invention.

The summary of the present invention is as follows:

In a first preferred embodiment, an L-shaped optical waveguide device according to the present invention includes an L-shaped optical waveguide wherein ends of two I-shaped optical waveguides are coupled to each other approximately at a right angle, and a photoelectric conversion element optically coupled to the L-shaped optical waveguide. A coupled end of a first I-shaped optical waveguide has a concave portion and a coupled end of a second I-shaped optical waveguide has a convex portion. A concave-convex joint is formed by fitting the concave portion with the convex portion. This enables the first and second I-shaped optical waveguides to be coupled to each other. A plurality of concave-convex joints may be formed. A plurality of cores which belong to the second I-shaped optical waveguide having a convex portion respectively bend approximately at a right angle near the photoelectric conversion element to be optically coupled to the photoelectric conversion element. The terms “approximately at a right angle” mean herein 90.5.

In a second preferred embodiment of an L-shaped optical waveguide device according to the present invention, the length of a first I-shaped optical waveguide having a concave portion is longer than the length of a second I-shaped optical waveguide having a convex portion.

In a third preferred embodiment of an L-shaped optical waveguide device according to the present invention, the number of a plurality of cores which belong to a first I-shaped optical waveguide having a concave portion is greater than the number of a plurality of cores which belong to a second I-shaped optical waveguide having a convex portion.

In a fourth preferred embodiment of an L-shaped optical waveguide device according to the present invention, a light-emitting surface of a first I-shaped optical waveguide having a concave portion and a light-emitting surface of a second I-shaped optical waveguide having a convex portion are disposed on a substantially identical surface. The terms “disposed on a substantially identical surface” mean herein that when a plurality of cores of the first I-shaped optical waveguide having a concave portion and a plurality of cores of the second I-shaped optical waveguide having a convex portion are optically coupled to one photoelectric conversion element, there is practically no difference between respective optical coupling efficiency.

In a fifth preferred embodiment of an L-shaped optical waveguide device according to the present invention, a plurality of cores of a first I-shaped optical waveguide having a concave portion and a plurality of cores of a second I-shaped optical waveguide having a convex portion are optically coupled to one photoelectric conversion element.

In a sixth preferred embodiment of an L-shaped optical waveguide device according to the present invention, a coupling by a convex-concave joint is fixed by an ultraviolet curable adhesive.

### ADVANTAGES OF THE INVENTION

It is possible to obtain the following advantages according to the present invention:

(1) It is possible to improve productivity of an L-shaped optical waveguide by the formation of the L-shaped optical waveguide by a combination of a plurality of I-shaped optical waveguides with high productivity.

(2) It is possible to keep assembly accuracy of two I-shaped optical waveguides which constitute an L-shaped optical waveguide high in X and Y direction.

(3) Only one photoelectric conversion element is needed.

According to the present invention, it is possible to assemble an L-shaped optical waveguide device so as to be substantially orthogonal to the two I-shaped optical waveguides by fitting a concave portion of a first I-shaped optical waveguide with a convex portion of a second I-shaped optical waveguide. Further, it is possible to minimize the number of the photoelectric conversion element to one by bending a plurality of cores of the second I-shaped optical waveguide having a convex portion at a right angle near the photoelectric conversion element.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a plan view of an L-shaped optical waveguide device of the present invention;

FIG. 2 is a plan view illustrating a method for assembling an L-shaped optical waveguide device of the present invention;

FIG. 3 is a side view of an L-shaped optical waveguide device seen from a photoelectric conversion element-side;

FIG. 4 is a plan view of another example of an L-shaped optical waveguide device of the present invention;

FIG. 5 is a plan view of a an optical touch panel using an L-shaped optical waveguide device;

FIG. 6 is a plan view of a frame-shaped optical waveguide of a conventional example 1;

FIG. 7 is a plan views of an L-shaped optical waveguide device of a conventional example 2;

FIG. 8 is a plan view of an L-shaped optical waveguide device of a conventional example 3; and

FIG. 9 is a plan view of an L-shaped optical waveguide device of a conventional example 4.

### DESCRIPTION OF THE PREFERRED EMBODIMENTS

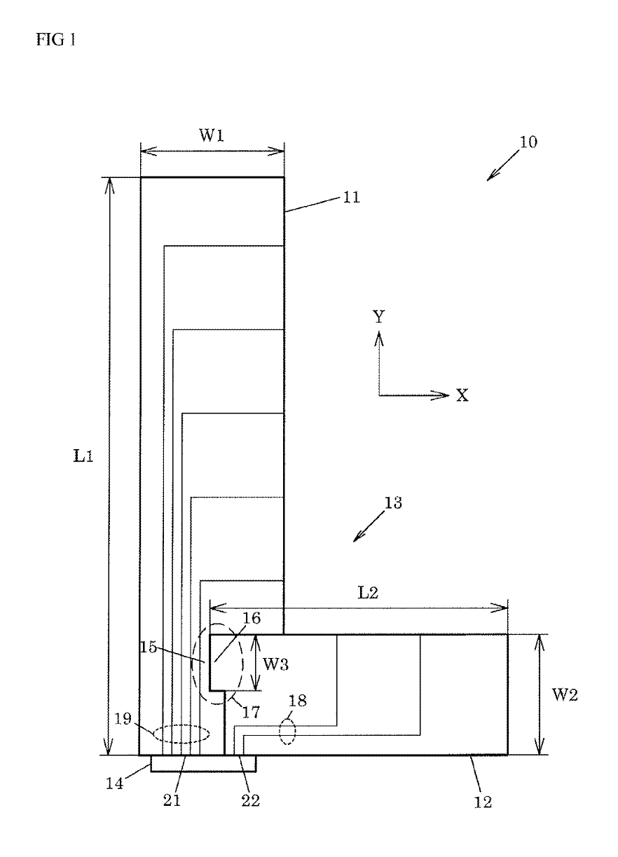

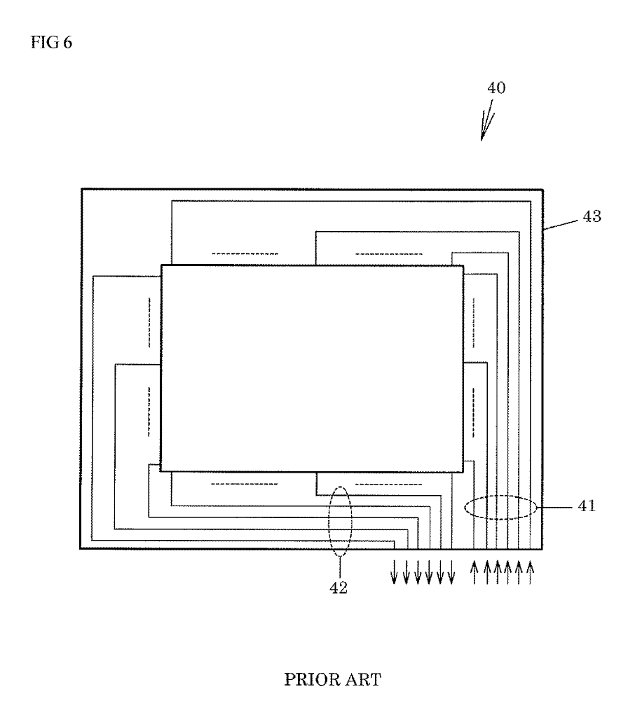

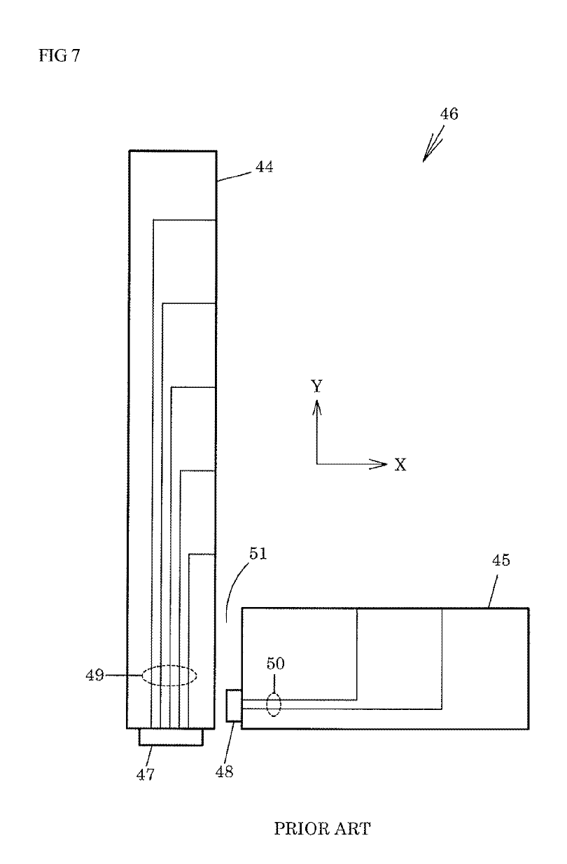

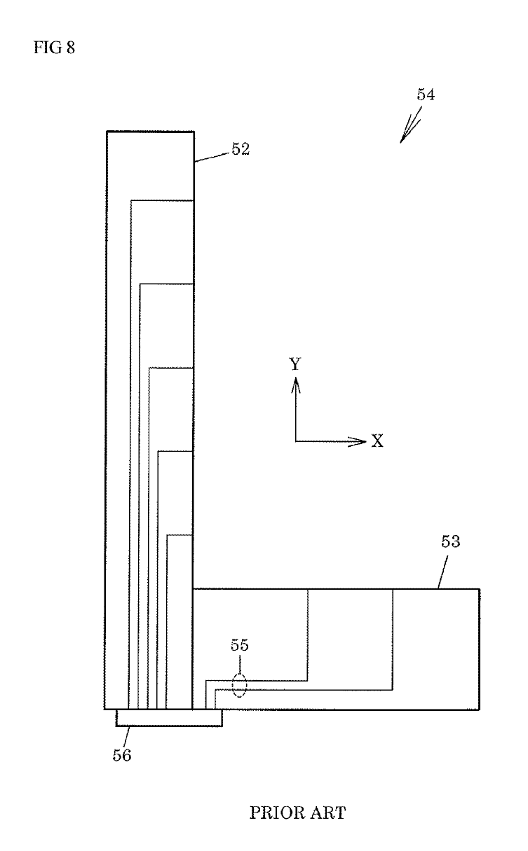

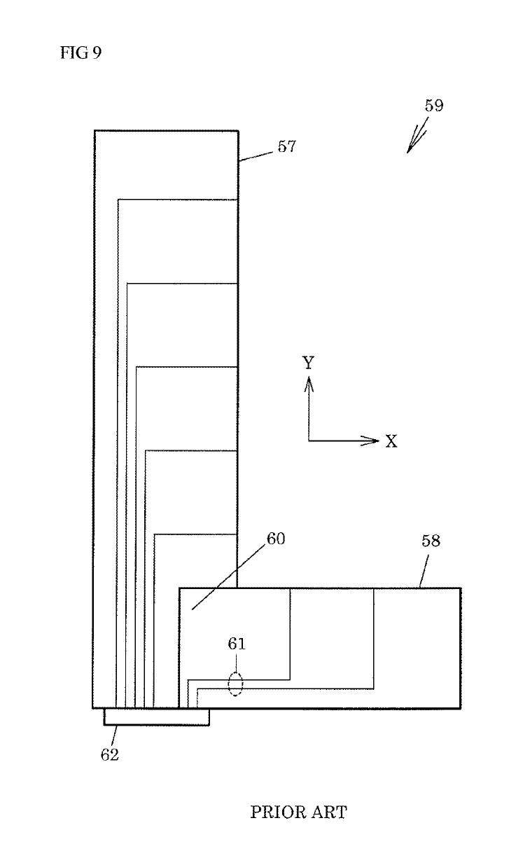

The preferred embodiments of the present invention will now be described with reference to FIGS. 1-9 of the drawings. Identical elements in the various figures are designated with the same reference numerals.

### [L-Shaped Optical Waveguide Device]

As shown in FIG. 1, an L-shaped optical waveguide device 10 of the present invention includes an L-shaped optical waveguide 13 wherein ends of two I-shaped optical waveguides 11, 12 are coupled to each other approximately at a right angle, and a photoelectric conversion element 14 optically coupled to the L-shaped optical waveguide 13. The terms “approximately at a right angle” mean herein 90.5.

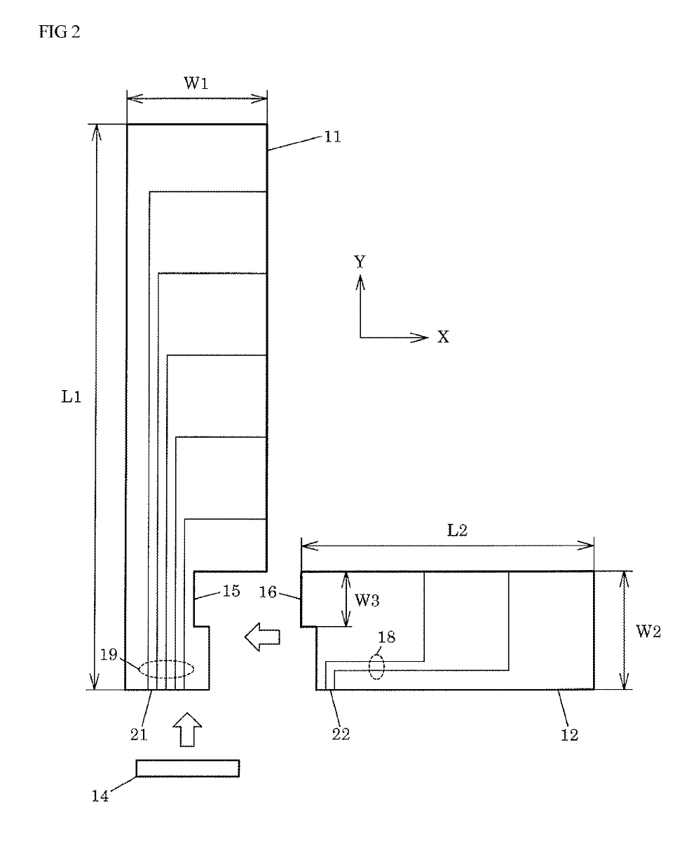

As shown in FIG. 2, in the L-shaped optical waveguide device 10 of the present invention, a coupled end of an I-shaped optical waveguide 11 in a Y direction has a concave portion 15 and a coupled end of an I-shaped optical waveguide 12 in an X direction has a convex portion 16.

As shown in FIG. 1, a concave-convex joint 17 is formed by fitting the concave portion 15 with the convex portion 16 and then the I-shaped optical waveguides 11, 12 are coupled to each other. A plurality of cores 18 which belong to the I-shaped optical waveguide 12 having the convex portion 16 respectively bend approximately at a right angle near the photoelectric conversion element 14 to be optically coupled to the photoelectric conversion element 14.

The phrase “bend approximately at a right angle near the photoelectric conversion element 14” has a meaning below. The cores 18 disposed at a place distant from the photoelectric conversion element 14 are nearly parallel to a long side of the I-shaped optical waveguide 12 having the convex portion 16. However, the cores 18 are nearly perpendicular to the long side of the I-shaped optical waveguide 12 having the convex portion 16 near the photoelectric conversion element 14. That is to allow light passing through the cores 18 to vertically enter the photoelectric conversion element 14 that comes in contact with the long side of the I-shaped optical waveguide 12 having the convex portion 16. In addition, the terms “nearly parallel” mean herein that a distortion from a true parallelism is within 5. And the terms “nearly perpendicular” mean herein that a distortion from a true perpendicularity is within 5.

### [L-Shaped Optical Waveguide]

As shown in FIG. 1, the L-shaped optical waveguide 13 to be used in the present invention is formed by combining ends of the two I-shaped optical waveguides 11, 12 together approximately at a right angle. The coupled end of the I-shaped optical waveguide 11 has the concave portion 15 and the coupled end of the I-shaped optical waveguide 12 has the convex portion 16. The two I-shaped optical waveguides 11, 12 are coupled to each other by the formation of a concave-convex joint 17 in which the concave portion 15 is fitted with the convex portion 16.

A plurality of concave-convex joints 17 may be provided in the L-shaped optical waveguide 13. Although the concave portion 15 and the convex portion 16 shown in FIG. 1 are respectively rectangular, the shape of the concave portion 15 and the convex portion 16 is not limited to this. The shape of the concave portion 15 and the convex portion 16 may be polygonal and curve-shaped, as long as the shape enables the fitting of the concave portion 15 with the convex portion 16.

Such coupling makes it possible to keep assembly accuracy of the two I-shaped optical waveguides 11, 12 high in X and Y directions, which leads to form the high-precision L-shaped optical waveguide 13.

As shown in FIG. 1, the I-shaped optical waveguides 11, 12 are in an elongated rectangular shape as a whole. It is preferable that the I-shaped optical waveguides 11, 12 respectively have widths of W1 and W2 of 10 mm to 30 mm. Lengths L1 and L2 of the I-shaped optical waveguides 11, 12 are adjusted appropriately according to the purpose and are typically 50 mm to 500 mm.

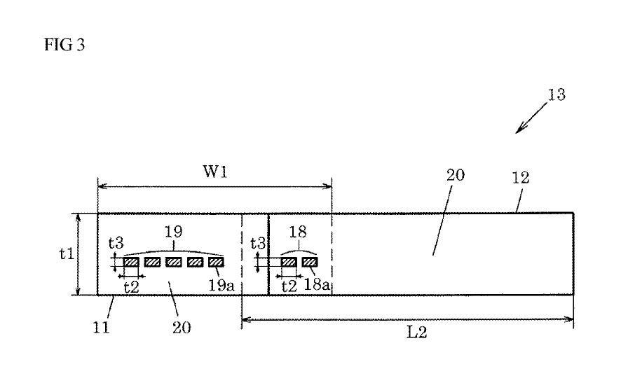

FIG. 3 is a side view of the L-shaped optical waveguide 13 seen from the photoelectric conversion element 14-side. As shown in FIG. 3, the I-shaped optical waveguides 11, 12 forming the L-shaped optical waveguide 13 respectively include a plurality of cores 18, 19 (set of a plurality of cores 18a and 19a) and a cladding-layer 20 in which the cores 18, 19 are embedded. A thickness t1 of the I-shaped optical waveguides 11, 12 is preferably 100 m to 2,000 m. Although each thickness t1 of the two I-shaped optical waveguides 11, 12 is usually equal, however, may be different.

The cores 18, 19 shown in FIG. 3 respectively have a refractive index higher than that of the cladding-layer 20 and are formed of a material having high transparency relative to light in a near-infrared area. The material for forming the cores 18, 19 is preferably an ultraviolet curable resin with superior patterning properties.

The cross-sectional shape of respective cores 18a, 19a is not particularly limited, but is preferably trapezoidal or rectangular. Respective cores 18a, 19a preferably have a width t2 of 10 m to 500 m. Respective cores 18a, 19a preferably have a height t3 of 10 m to 100 m.

The cladding layer 20 is formed of any material having a lower refractive index than that of the cores 18a, 19a. It is possible to adjust the refractive index of a resin in the material forming the cores 18a, 19a and the cladding layer 20 to be higher or lower in accordance with the kind of organic groups introduced in the resin or a content of the organic groups in the resin. Examples of the material for forming the cores 18a, 19a and the cladding-layer 20 include materials listed in Examples in JP 2010-32661 A.

The cores 18 that belong to the I-shaped optical waveguide 12 having the convex portion 16 respectively bend approximately at a right angle near the photoelectric conversion element 14 to be optically coupled to the photoelectric conversion element 14. The cores 19 that belong to the I-shaped optical waveguide 11 having the concave portion 15 linearly extend (may bend in the middle) to the photoelectric conversion element 14 to be optically coupled to the photoelectric conversion element 14.

As shown in FIG. 1, it is possible to allow a light-emitting surface 21 of the I-shaped optical waveguide 11 having the concave portion 15 and a light-emitting surface 22 of the I-shaped optical waveguide 12 having the convex portion 16 to be disposed on a substantially identical surface by making the shape of the cores 18, 19 as described above. This makes it possible to optically couple the cores 19 of the I-shaped optical waveguide 11 having the concave portion 15 and the cores 18 of the I-shaped optical waveguide 12 having the convex portion 16 to one photoelectric conversion element 14.

In the L-shaped optical waveguide device 10 of the present invention, the length L1 of the I-shaped optical waveguide 11 having the concave portion 15 is preferably longer than the length L2 of the I-shaped optical waveguide 12 having the convex portion 16. The difference (L1 L2) between the length L1 of the I-shaped optical waveguide 11 having the concave portion 15 and the length L2 of the I-shaped optical waveguide 12 having the convex portion 16 is set appropriately according to the purpose, but is preferably 20 mm to 200 mm.

In the L-shaped optical waveguide device 10 of the present invention, the number of the cores 19a that belong to the I-shaped optical waveguide 11 having the concave portion 15 is preferably greater than the number of the cores 18a that belong to the I-shaped optical waveguide 12 having the convex portion 16. The number of the cores 19a that belong to the I-shaped optical waveguide 11 having the concave portion 15 is preferably 40 to 700. The number of the cores 18a that belong to the I-shaped optical waveguide 12 having the convex portion 16 is preferably 30 to 500.

According to the present invention, the L-shaped optical waveguide 13 with smaller widths W1 and W2 than those of conventional ones may be obtained. In the case of the L-shaped optical waveguide 13 having an opposite angle of 10.4 inches (horizontal to vertical ratio: 4:3), the widths W1 and W2 are as below.

As shown in FIG. 1, when the I-shaped optical waveguide 12 having the convex portion 16 is a shorter side, the maximum width of the L-shaped optical waveguide 13 is the width W1 of the I-shaped optical waveguide 11 having the concave portion 15 and is 14.4 mm.

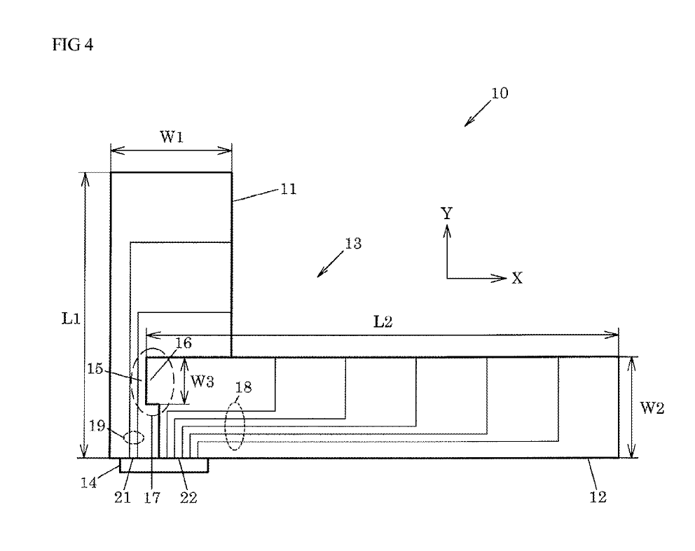

As shown in FIG. 4, when the I-shaped optical waveguide 12 having the convex portion 16 is a longer side, the maximum width of the L-shaped optical waveguide 13 is the width W2 of the I-shaped optical waveguide 12 having the convex portion 16 and is 15.0 mm.

Accordingly, it is possible to reduce the maximum width (W1 or W2) of the L-shaped optical waveguide 13 by making the length L1 of the I-shaped optical waveguide 11 having the concave portion 15 longer than the length L2 of the I-shaped optical waveguide 12 having the convex portion 16.

A width W3 of the convex portion 16 of the concave-convex joint 17 in the L-shaped optical waveguide 13 to be used in the present invention shown in FIG. 1 is preferably 5 mm to 15 mm. It is possible to firmly couple respective I-shaped optical waveguides 11, 12 to each other by setting the dimensions of the concave-convex joint 17 as described above.

### [Photoelectric Conversion Element]

The photoelectric conversion element 14 to be used in the present invention is optically coupled to the cores 18, 19 of the L-shaped optical waveguide 13 to convert optical signals into electrical signals. Examples of the photoelectric conversion element 14 typically include a CMOS linear image sensors and CCD linear image sensors. Such a photoelectric conversion element 14 has a plurality of phtodiodes (light-receiving sections) linearly arranged.

At the time of optical coupling, the position of the photoelectric conversion element 14 is adjusted so that an output electrical signal may be maximized when light traveling through the cores 18, 19 of respective I-shaped optical waveguides 11, 12 enters the photoelectric conversion element 14. Subsequently, the photoelectric conversion element 14 is fixed to respective I-shaped optical waveguides 11, 12 by an ultraviolet curable adhesive.

### Example

### Formation of L-Shaped Optical Waveguide 13

A plurality of cores 18 formed of an epoxy-based resin including a fluorene skeleton were formed on a surface of an under-cladding layer made of an epoxy-based resin including an alicyclic skeleton by an exposure development method. The under-cladding layer has a thickness of 20 m and a refractive index of 1.51. Cores 18a respectively have a height t3 of 50 m, a width t2 of 15 m, and a refractive index of 1.59. The number of cores 18a is 62.

An over-cladding layer wherein the cores 18 were embedded was formed on a surface of the under-cladding layer. The over-cladding layer has a thickness of 1 mm and the material thereof is the same as that of the under-cladding layer.

In this way, an I-shaped optical waveguide 12 having a convex portion 16 was formed. The dimensions of the I-shaped optical waveguide 12 were W2=15 mm, L2=172 mm, and t1=1,020 m.

Similarly, a plurality of cores 19 were formed on a surface of an under-cladding layer and an over-cladding layer wherein the cores 19 were embedded was formed to form an I-shaped optical waveguide 11 having a concave portion 15. Cores 19a respectively have a height t3 of 50 m and a width t2 of 15 m. The number of cores 19a is 82. The dimensions of the I-shaped optical waveguide 11 are W1=13 mm, L1=234 mm, t1=1,020 m.

The I-shaped optical waveguide 12 having the convex portion 16 was coupled to the I-shaped optical waveguide 11 having the concave portion 15 so as to form a concave-convex joint 17 by fitting the convex portion 16 with the concave portion 15 and then fix the I-shaped optical waveguide 12 having the convex portion 16 and the I-shaped optical waveguide 11 having the concave portion 15 by an ultraviolet curable adhesive. As a result, an L-shaped optical waveguide 13 was formed.

A light-emitting surface 22 of the I-shaped optical waveguide 12 having the convex portion 16 is disposed on a substantially identical surface of a light-emitting surface 21 of the I-shaped optical waveguide 11 having the concave portion 15. The light-emitting surface 22 of the I-shaped optical waveguide 12 having the convex portion 16 and the light-emitting surface 21 of the I-shaped optical waveguide 11 having the concave portion 15 were optically coupled to a photoelectric conversion element 14 (manufactured by Hamamatsu Photonics K.K., product name: CMOS linear image sensor) and fixed via an ultraviolet curable adhesive. As a result, an L-shaped optical waveguide device 10 was manufactured.

The thus manufactured L-shaped optical waveguide device 10 is capable of:
(1) assembling two high-precision I-shaped optical waveguides 11, 12,
(2) while maintaining a high transmission efficiency,
(3) detecting emitting light of the two I-shaped optical waveguides 11, 12 using one photoelectric conversion element 14.

### INDUSTRIAL APPLICABILITY

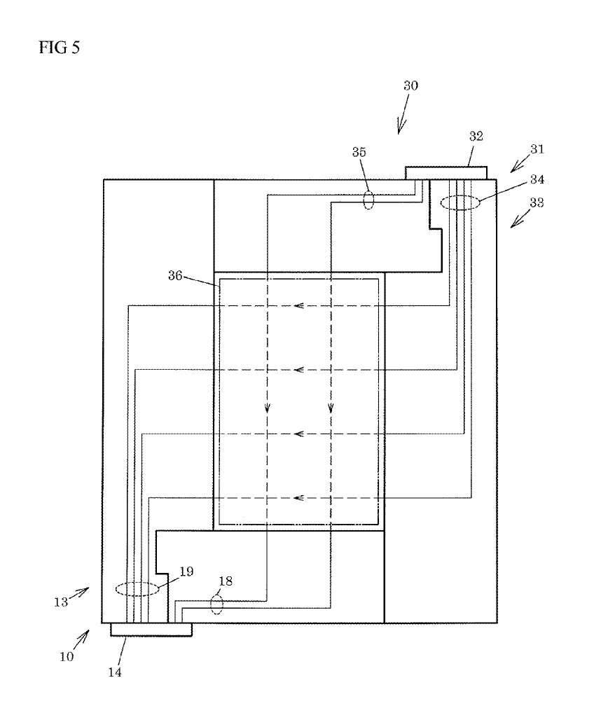

Applications of the L-shaped optical waveguide device 10 of the present invention are not particularly limited, but the L-shaped optical waveguide device 10 is preferably used for an optical touch panel 30 shown in FIG. 5. In the optical touch panel 30, one L-shaped optical waveguide device 10 is used at a light-receiving side and another L-shaped optical waveguide device 31 is used at a light-emitting side. In the light-emitting-sided L-shaped optical waveguide device 31, a photoelectric conversion element 32 for converting electrical signals into light is used instead of the photoelectric conversion element 14 for converting light into electrical signals.

Optical groups emitted from the photoelectric conversion element 32 pass through a plurality of cores 34, of a light-emitting-sided L-shaped optical waveguide 33 and then emit to a coordinate input region 36. The optical groups having passed through the coordinate input region 36 enter the light-receiving-sided L-shaped optical waveguide 13 and then pass through the cores 18, 19 of the L-shaped optical waveguide 13 to enter the photoelectric conversion element 14. Since the optical groups in the coordinate input region 36 are partially blocked by a finger or a pen, the optical groups to enter the photoelectric conversion element 14 partially disappear, the position coordinate of the finger or the pen is detected.

This application claims priority from Japanese Patent Application No. 2010-127712, which is incorporated herein by reference.

There has thus been shown and described a novel L-shaped optical waveguide device which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. An L-shaped optical waveguide device including an L-shaped optical waveguide wherein ends of two I-shaped optical waveguides are coupled to each other approximately at a right angle, and a photoelectric conversion element optically coupled to the L-shaped optical waveguide,
wherein a coupled end of a first I-shaped optical waveguide has a concave portion and a coupled end of a second I-shaped optical waveguide has a convex portion,
a concave-convex joint is formed by fitting the concave portion with the convex portion to couple the first and second I-shaped optical waveguides, and
a plurality of cores which belong to the second I-shaped optical waveguide having the convex portion respectively bend approximately at a right angle near the photoelectric conversion element to be optically coupled to the photoelectric conversion element.

2. The device according to claim 1, wherein the length of the first I-shaped optical waveguide having the concave portion is longer than the length of the second I-shaped optical waveguide having the convex portion.

3. The device according to claim 1 or claim 2, wherein the number of a plurality of cores which belong to the first I-shaped optical waveguide having the concave portion is greater than the number of a plurality of cores which belong to the second I-shaped optical waveguide having the convex portion.

4. The device according to claim 1 or claim 2, wherein a light-emitting surface of the first I-shaped optical waveguide having the concave portion and a light-emitting surface of the second I-shaped optical waveguide having the convex portion are disposed on a substantially identical surface.

5. The device according to claim 1 or claim 2, wherein a plurality of cores of the first I-shaped optical waveguide having the concave portion and a plurality of cores of the second I-shaped optical waveguide having the convex portion are optically coupled to one photoelectric conversion element.

6. The device according to claim 1 or claim 2, wherein a coupling by the convex-concave joint is fixed by an ultraviolet curable adhesive.
